(19) United States
(12) Patent Application Publication
(10) Pub. No.: US 2014/0169737 A1
(43) Pub. Date: Jun. 19, 2014

(54) TRANSCEIVER WITH SELF-REGISTERED WAVELENGTHS

(71) Applicant: ORACLE INTERNATIONAL CORPORATION, Redwood City, CA (US)

(72) Inventors: Xuezhe Zheng, San Diego, CA (US); Ying L. Luo, San Diego, CA (US); Ashok V. Krishnamoorthy, San Diego, CA (US)

(73) Assignee: ORACLE INTERNATIONAL CORPORATION, Redwood City, CA (US)

(21) Appl. No.: 13/717,359

(22) Filed: Dec. 17, 2012

(51) Int. Cl. G02B 6/34

(52) U.S. Cl. CPC G02B 6/34
USPC 385/37

(57) ABSTRACT

An integrated optical component outputs and receives an optical signal that provides a comb of modulated wavelengths for use in wavelength-division-multiplexing (WDM) optical interconnects or links. In particular, a shared echelle grating is used as a wavelength-selective filter or control device for multiple lasing cavities to achieve self-registered and accurate lasing-channel spacing without inter-channel gain competition for multiplexing modulated wavelength channels into one transmit port, and for receiving and de-multiplexing WDM wavelength channels simultaneously. The wavelength alignment between a pair of such transceivers can be achieved by tuning the echelle grating on one side using thermal-optical or electro-optical effects. Furthermore, tunable ring-resonator modulators, broadband electro-absorption modulators (EAMs) or Mach-Zehnder Interferometer (MZI) optical modulators on the shared output waveguide outside of the lasing cavities can be used to modulate the wavelengths. The optical component can be used to provide all the wavelength channels in one optical waveguide.

### GOVERNMENT LICENSE RIGHTS

This invention was made with United States government support under Agreement No. HR0011-08-9-0001 awarded by DARPA. The United States government has certain rights in the invention.

### BACKGROUND

1. Field

The present disclosure relates to techniques for communicating optical signals. More specifically, the present disclosure relates to an integrated circuit that includes an optical component, such as an optical transmitter and/or receiver.

2. Related Art

Wavelength-division-multiplexing (WDM) silicon-photonic link technology is widely viewed as promising technology that can provide large communication bandwidth, low latency and low power consumption for inter-chip and intra-chip connections. However, the use of WDM significantly complicates the silicon-photonic link.

In particular, on the transmitter side, WDM continuous-wave (CW) laser sources with different wavelengths and fixed wavelength spacing are needed to provide optical-carrier signals. After modulating the carrier wavelengths in the WDM CW optical-carrier signals using modulators (such as electro-optic modulators which convert electrical data into modulated optical signals that convey wavelength channels), an optical-wavelength multiplexer is used to combine the modulated optical-carrier signals into one optical waveguide, which provides the WDM transmitter output. On the receiver side, the received modulated optical-carrier signals are separated using an optical-wavelength de-multiplexer. Then, the separated optical-carrier signals are received by optical receivers and are converted back to electrical data.

In order for the WDM silicon-photonic link to work in concert with the transceivers described above, the wavelengths used by all the WDM components needs to be aligned on a per-channel basis. For example, a predetermined WDM wavelength grid is typically used as a wavelength reference, and the laser sources are closed-loop controlled and locked to the WDM wavelength grid based on temperature-controlled wavelength-reference devices (such as free-space etalons). Moreover, each of the modulated optical-carrier signals (i.e., the wavelength channels) usually has a dedicated controller. Furthermore, the multiplexer and the de-multiplexer are typically tuned and controlled in alignment with the same wavelength grid. Because the center wavelengths of WDM filters, and in particular resonant WDM filters, are often subject to manufacturing tolerances and ambient temperature changes, separate tuning and control are often required to make sure that all of the wavelength channels are aligned with the wavelength grid. These complicated wavelength controls significantly increase the cost and power consumption of WDM transceivers, and make it more difficult to integrate silicon-photonic links.

Hence, what is needed is an integrated optical transmitter and/or receiver without the above-described problems.

### SUMMARY

One embodiment of the present disclosure provides an optical component. This optical component includes a first mirror that at least partially reflects a first optical signal having multiple wavelengths, and a first optical waveguide, optically coupled to the first mirror, that conveys the first optical signal. Moreover, the optical component includes a second optical waveguide that outputs a second optical signal having multiple modulated wavelengths. A wavelength-control device in the optical component, which is optically coupled to the first optical waveguide and the second optical waveguide, includes an optical device that images and diffracts using a reflective geometry: the first optical signal along a first direction into third optical signals having the wavelengths along third directions; and fourth optical signals having the modulated wavelengths along fourth directions into the second optical signal along a second direction. Note that a given third optical signal includes a given wavelength and a given fourth optical signal includes a given modulated wavelength. Additionally, the optical component includes optical paths, optically coupled to pairs of diffraction orders of the optical device, including: third optical waveguides that convey the third optical signals; optical gain mechanisms that amplify the third optical signals; second mirrors that at least partially reflect the third optical signals; modulators that generate the fourth optical signals by modulating the third optical signals; and fourth optical waveguides that convey the fourth optical signals.

Note that a given optical path includes: a given third optical waveguide, optically coupled to a given diffraction order, that conveys the given third optical signal; a given optical gain mechanism, optically coupled to the given third optical waveguide, that amplifies the given third optical signal; and a given second mirror, optically coupled to the given third optical waveguide, that at least partially reflects the given third optical signal. The optical paths may include optical phase-tuning mechanisms, where a given optical phase-tuning mechanism is optically coupled to the given third optical waveguide and adjusts a phase of the given third optical signal. In some embodiments, the optical phase-tuning mechanisms have a different band gap than that of the optical gain mechanisms. Alternatively, the optical phase-tuning mechanisms may include heaters configured to modify temperatures of the optical phase-tuning mechanisms.

Additionally, the given optical path may include: a given modulator, optically coupled to a given second mirror, that modulates the given third optical signal to generate the given fourth optical signal; and a given fourth optical waveguide, optically coupled to a given diffraction order, that conveys the given fourth optical signal. For example, the modulators may include tunable ring-resonator modulators or broadband electro-absorption modulators (EAMs).

Moreover, the first mirror and/or the second mirrors may include a distributed Bragg reflector. Alternatively or additionally, the first mirror may include a metal disposed on a surface of the first optical waveguide and/or the second mirrors may include metal disposed on surfaces of the third optical waveguides.

Furthermore, the optical gain mechanisms may receive electrical currents to electrically pump the third optical signals.

Note that an incidence angle associated with a given diffraction order of the optical device may be different than a diffraction angle associated with the given diffraction order. Moreover, the optical device may include a diffraction grating on a curved surface. For example, the optical device may include an echelle grating.

In some embodiments, the optical component includes: a substrate; a buried-oxide layer disposed on the substrate; and a semiconductor layer disposed on the buried-oxide layer, where the first optical waveguide, the second optical waveguide, the third optical waveguides and the fourth optical waveguides are included in the semiconductor layer. For example, the substrate may include a semiconductor. Moreover, the wavelength-control filter may be included in the semiconductor layer. Additionally, the optical gain mechanisms may include at least a different semiconductor than that in the semiconductor layer.

In some embodiments, the optical component includes: a fifth optical waveguide, optically coupled to the wavelength-control device, that receives a fifth optical signal having additional wavelengths. In these embodiments, using the reflective geometry the optical device may image and diffract the fifth optical signal along a fifth direction into sixth optical signals having the additional wavelengths along sixth directions, where a given sixth optical signal includes a given additional wavelength. Furthermore, additional optical paths, optically coupled to additional diffraction orders of the optical device, may include sixth optical waveguides and optical detectors, where a given additional optical path includes a given sixth optical waveguide and a given optical detector. The given optical detector may detect the given sixth optical signal conveyed by the given sixth optical waveguide.

Additionally, the fifth optical waveguide may include a pair of optical waveguides that receive different polarization components of the fifth optical signal. Therefore, the wavelength-control device may be optically coupled to the pair of optical waveguides.

Another embodiment provides a system that includes the optical component.

Another embodiment provides a method for providing the optical signals, which may be performed by the optical component. During the method, the first optical signal having multiple wavelengths is at least partially reflected using the first mirror. Then, the first optical signal is conveyed in the first optical waveguide. Moreover, using the reflective geometry of the optical device in the wavelength-control device, the first optical signal along the first direction is imaged and diffracted into the third optical signals having the wavelengths along the third directions, where the given third optical signal includes the given wavelength.

Next, the third optical signals are conveyed in the third optical waveguides, where the given third optical waveguide conveys the given third optical signal. Furthermore, the third optical signals are amplified using the optical gain mechanisms optically coupled to the third optical waveguides, where the given optical gain mechanism amplifies the given third optical signal. Additionally, the third optical signals are at least partially reflected using the second mirrors, where the given second mirror at least partially reflects the given third optical signal.

Then, the third optical signals are modulated using the modulators to generate the fourth optical signals having the modulated wavelengths. The fourth optical signals are conveyed in the fourth optical waveguides, where the given fourth optical waveguide includes the given fourth optical signal. Next, using the reflective geometry of the optical device in the wavelength-control device, the fourth optical signals along the fourth directions are imaged and diffracted into the second optical signal having the modulated wavelengths along the second direction, where the given fourth optical signal includes the given modulated wavelength. Furthermore, the second optical signal is output in the second optical waveguide.

### BRIEF DESCRIPTION OF THE FIGURES

FIG. 1 is a block diagram illustrating an optical component in accordance with an embodiment of the present disclosure.

FIG. 2 is a block diagram illustrating an optical component in accordance with an embodiment of the present disclosure.

FIG. 3 is a block diagram illustrating an optical component in accordance with an embodiment of the present disclosure.

FIG. 4 is a block diagram illustrating a side view of an integrated circuit that includes the optical component of FIG. 1, 2 or 3 in accordance with an embodiment of the present disclosure.

FIG. 5 is a block diagram illustrating a system that includes the optical component of FIG. 1, 2 or 3 in accordance with an embodiment of the present disclosure.

FIG. 6A is a flow chart illustrating a method for providing an optical signal in accordance with an embodiment of the present disclosure.

FIG. 6B is a flow chart illustrating the method of FIG. 6A for providing an optical signal in accordance with an embodiment of the present disclosure.

Table 1 provides design parameters for an echelle grating in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

Embodiments of an optical component, a system that includes the optical component, and a method for providing an optical signal are described. This integrated optical component may output and receive an optical signal that provides a comb of modulated wavelengths for use in wavelength-division-multiplexing (WDM) optical interconnects or links. In particular, a shared echelle grating is used as a wavelength-selective filter or control device for multiple lasing cavities to achieve self-registered and accurate lasing-channel spacing without inter-channel gain competition for multiplexing modulated wavelength channels into one transmit port, and for receiving and de-multiplexing WDM wavelength channels simultaneously. The wavelength alignment between a pair of such transceivers can be achieved by tuning the echelle grating on one side using thermal-optical or electro-optical effects. Furthermore, tunable ring-resonator modulators, broadband electro-absorption modulators (EAMs) or Mach-Zehnder Interferometer (MZI) optical modulators on the shared output waveguide outside of the lasing cavities can be used to modulate the wavelengths. The optical component can be used to provide all the wavelength channels in one optical waveguide.

In addition, diffraction orders of the echelle grating may be coupled to photo-detectors so the optical component can transmit the optical signal and/or receive additional optical signals conveyed on another optical waveguide. Thus, the optical component may be a WDM transmitter and/or a receiver.

This low-cost WDM optical component may facilitate WDM silicon-photonic links, thereby significantly improving the performance of the optical interconnects (such as the bandwidth density and the power consumption) and computing systems that include the optical interconnects.

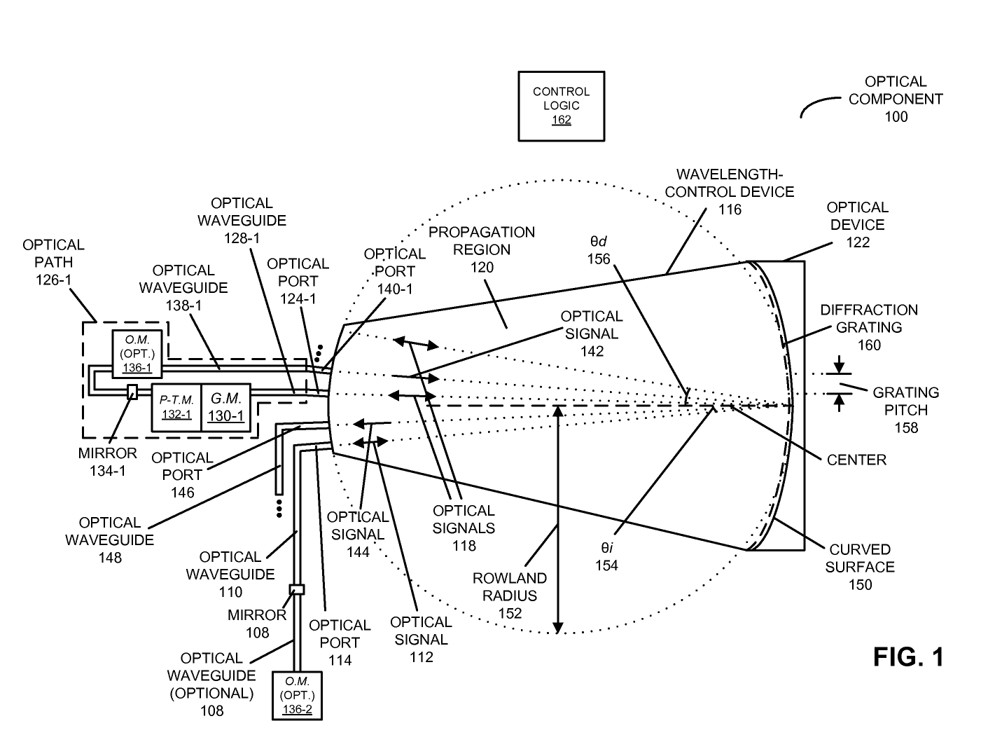

We now describe embodiments of the optical component. FIG. 1 presents a block diagram illustrating an optical component 100. This optical component includes: a mirror 108 (such as a distributed Bragg reflector or metal disposed on an end surface of optical waveguide 110 with a high reflectivity, e.g. 99%) that at least partially reflects optical signal 112 having multiple wavelengths; optical waveguide 110, optically coupled to mirror 108, that conveys optical signal 112; a wavelength-control device 116 that multiplexes and de-multiplexes optical signals; and optical paths (such as optical path 126-1) optically coupled to wavelength-control device 116. This wavelength-control device includes: an optical port 114 that couples to optical waveguide 110; a propagation region 120 that conveys optical signal 112; and an optical device 122 that images and diffracts optical signal 112 using a reflective geometry in a first propagation direction, and that images and diffracts optical signals 118 having the wavelengths using the reflective geometry in a third propagation direction, where a given one of optical signals 118 has a given wavelength. Moreover, wavelength-control device 116 includes optical ports (such as optical port 124-1), optically coupled to diffraction orders of optical device 122, that convey optical signals 118 having the wavelengths, where a given one of the optical ports provides the given one of optical signals 118.

Furthermore, optical paths, such as optical path 126-1 (which are optically coupled to the optical ports) include: optical waveguides (such as optical waveguide 128-1) that convey optical signals 118; optical gain mechanisms (G.M.), such as optical gain mechanism 130-1, that amplify optical signals 118; and mirrors, such as mirror 134-1, that at least partially reflect optical signals 118 (such as distributed Bragg reflectors or metal disposed on end surfaces of the optical waveguides with a lower reflectivity, e.g., 90%). For example, during operation of optical component 100, the optical gain mechanisms may receive electrical currents to electrically pump optical signals 118.

Additionally, a given optical path (such as optical path 126-1) may include: a given one of the optical waveguides (such as optical waveguide 128-1) optically coupled to a given optical port (such as optical port 124-1), that conveys the given one of optical signals 118; a given optical gain mechanism (such as optical gain mechanism 130-1), optically coupled to the given one of the optical waveguides, that amplifies the given one of optical signals 118; and a given mirror (such as mirror 134-1), optically coupled to the given one of the optical waveguides, that at least partially reflects the given one of optical signals 118.

In some embodiments, the optical paths include optional optical phase-tuning mechanisms (P-T.M.), such as optional optical phase-tuning mechanism 132-1, where a given optical phase-tuning mechanism is optically coupled to the given one of the optical waveguides and adjusts a phase of the given one of optical signals 118. These optional optical phase-tuning mechanisms may be used to fine-tune one or more of the cavity modes so that they are aligned with the center wavelength of the echelle grating to improve the lasing performance.

Note that the optional optical phase-tuning mechanisms may have a different or the same band gap than that of the optical gain mechanisms. For example, the optical gain mechanisms may include a III-V semiconductor or germanium and the optional optical phase-tuning mechanisms may include silicon. These components may be wafer bonded to each other, may involve edge coupling of III-V optical waveguides to silicon optical waveguides, or may involve surface-normal coupling of III-V optical waveguides to silicon optical waveguides. Alternatively, the optional optical phase-tuning mechanisms may be included in the optical gain mechanisms. Note that the optional optical phase-tuning mechanisms may align optical cavity modes with peak wavelengths of wavelength-control device 116.

Moreover, the optional optical phase-tuning mechanisms may include heaters (not shown) that modify temperatures of the optical phase-tuning mechanisms. Alternatively or additionally, the optional optical phase-tuning mechanisms may use carrier-based index modulation (such as PIN forward injection).

Additionally, the optical paths may include: optical modulators (O.M.), such as optional optical modulator 136-1, that generate optical signals (such as optical signal 142) by modulating optical signals 118, and optical waveguides (such as optical waveguide 138-1) that convey the optical signals (such as optical signal 142). The given optical path (such as optical path 126-1) may include: a given one of the optical modulators (such as optical modulator 136-1), optically coupled to a given mirror (such as mirror 134-1), that modulates one of optical signals 118 to generate one of the optical signals (such as optical signal 142); and a given one of the optical waveguides (such as optical waveguide 138-1), optically coupled to one of the optical ports (such as optical port 140-1), that conveys the one of the optical signals (such as optical signal 142). For example, the modulators may include tunable ring-resonator modulators or broadband EAMs. Alternatively or additionally, electro-absorption modulators or Mach-Zehnder Interferometer (MZI) optical modulators may be used.

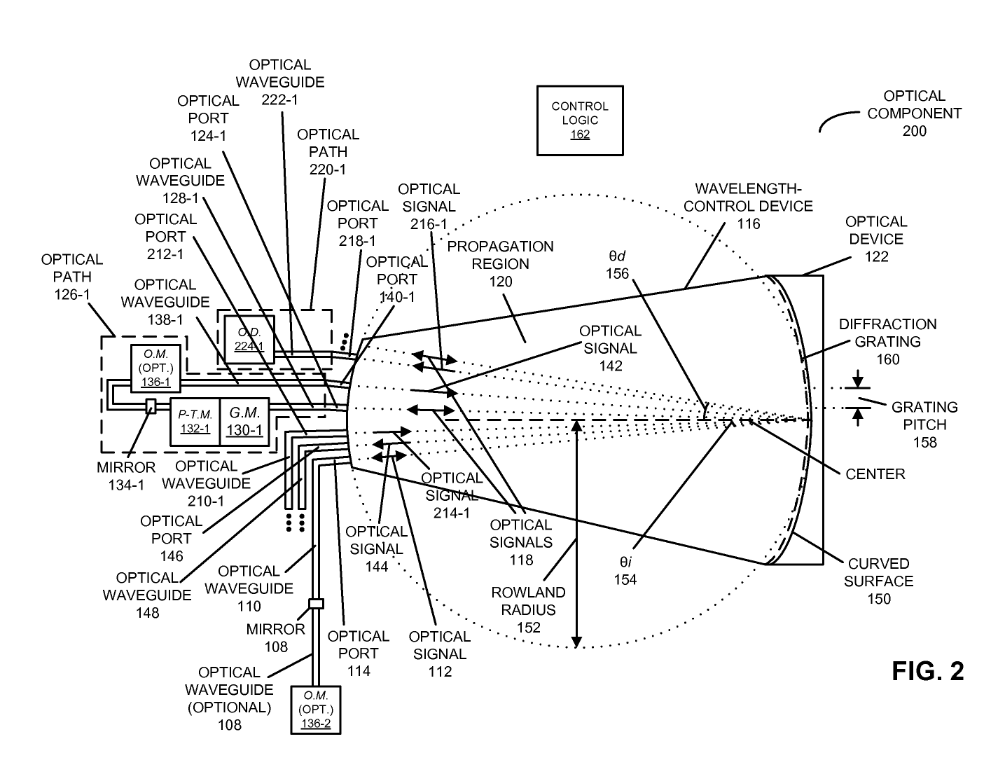

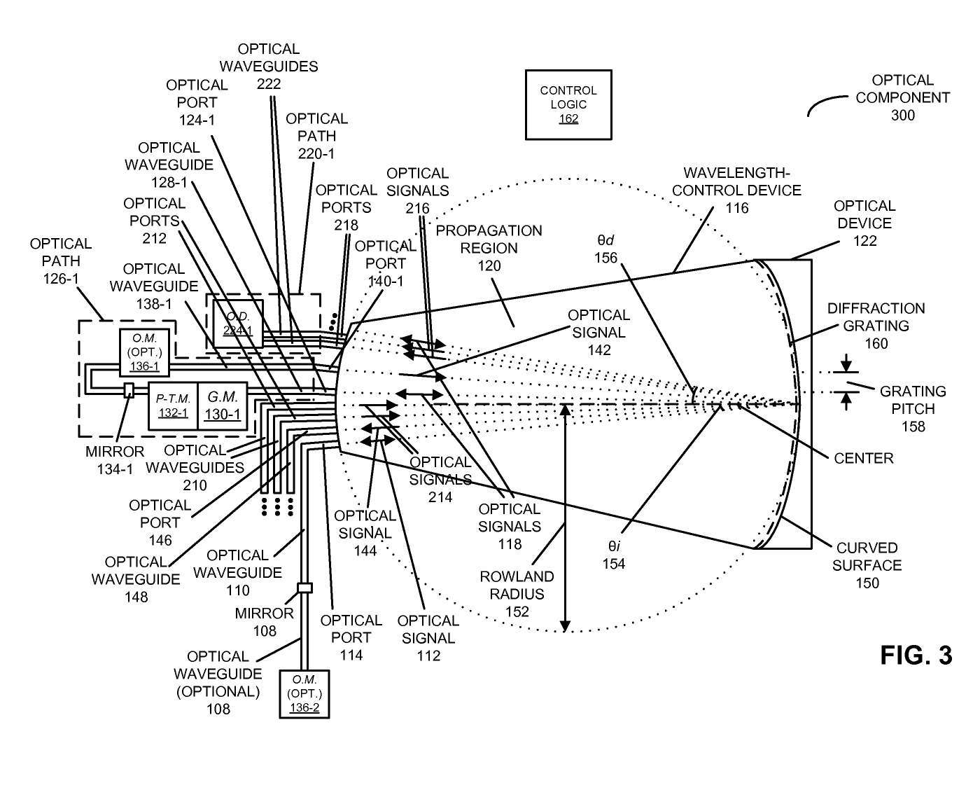

As shown in FIG. 1, the optical modulators may be external to the optical or lasing cavities. While the optical modulators shown in FIG. 1 (and in FIGS. 2 and 3) may be located in the optical waveguides, such as optical waveguide 138-1 (for example, if they are electro-absorption modulators or MZI optical modulators), in other embodiments the optical modulator (such as optional optical modulator 136-2) may be included in an optional optical waveguide 106 that is outside of the lasing cavity and is coupled to mirror 108 (for example, if the optical modulators are cascaded ring-resonator modulators).

Optical device 122 in wavelength-control device 116 images and diffracts the optical signals (such as optical signal 142) using a reflective geometry in a fourth propagation direction, and then images and diffracts optical signal 144 having the modulated wavelengths using the reflective geometry in a second propagation direction, where a given one of the optical signals in the fourth propagation direction has a given modulated wavelength.

Then, optical signal 144 is output on optical waveguide 148, which is optically coupled to optical port 146 of wavelength-control device 116. In this way, optical component 100 can provide an optical signal with a predefined channel spacing (such as those used in WDM).

In some embodiments, optical device 122 may include a diffraction grating 160 on a curved surface 150 having a radius of twice Rowland radius 152, such as an echelle grating. Thus, an incidence angle (θᵢ) 154 associated with a diffraction order may be different than a diffraction angle (θ_{d}) 156 associated with the diffraction order. Moreover, a grating pitch 158 of diffraction grating 160 may be greater than or equal to 20 μm and/or Rowland radius 152 may be less than 1 mm.

Note that an echelle grating separates or combines multiple wavelength signals with one shared grating structure. Effectively, an echelle grating integrates multiple wavelength filters. With an appropriate arrangement of the input and output optical waveguides (such as optical waveguides 110, 128-1, 138-1 and 148), accurate and uniform channel spacing can be achieved using a grating pitch 158 that is based on an effective index of refraction of propagation region 120 (such as that of silicon).

Using an echelle grating as an integrated multi-channel wavelength filter (i.e., wavelength-control device 116), optical component 100 may provide a WDM transmitter based on a multi-wavelength laser source with a self-registered channel spacing. As depicted in FIG. 1, an echelle grating multiplexer/demultiplexer can be designed with multiple input ports, each having its own corresponding set of output ports with the same wavelength channel spacing. For example, an input optical waveguide (optical waveguide 110) can have multiple corresponding output optical waveguides (such as optical waveguide 128-1) filtering out different wavelength channels coming from the input optical waveguide. Mirrors (such as mirrors 108 and 134-1) define ends of optical cavities. Then, by including an active gain medium (such as one of the optical gain mechanisms) and the optional optical phase-tuning mechanisms in one of the output optical waveguides (such as optical waveguide 128-1), a wavelength-specific optical cavity may be defined. Note that the echelle grating in this optical cavity may determine the lasing wavelength, such as one of wavelengths λ₁-λ₄. (More generally, the optical component may be used with 2, 4, 8, 16, 32, 64, 128 or 2^{N} wavelengths, where N is a non-zero integer.) This may be repeated for other output optical waveguides (which share wavelength-control device 116), thereby simultaneously establishing multiple lasing cavities with built-in wavelength registration.

By including each of the gain sections in the output optical waveguides, these gain sections may be dedicated to particular wavelengths by the echelle grating. This configuration may prevent multiple wavelengths from sharing the same gain medium and creating mode competition that can reduce the efficiency of each sub-laser, and may also result in mode and wavelength hopping. Furthermore, by separating the gain sections, a particular laser wavelength can be electrically turned off by not pumping carriers (via an electrical current) into the corresponding gain section. This is because each of the lasing wavelengths in the comb is independent of the others and has separate gain sections so that only the wavelengths necessary for operation at a given time need to be created. In this way, the efficiency can be increased and the total power consumption can be decreased.

Additionally, the spacing of the wavelengths (i.e., the spacing of the comb) is also controlled by the echelle grating which is common in the optical cavities. Therefore, tracking and control of the individual wavelengths in the comb with respect to each other may not be necessary because all of the wavelength channels may self-register to each other with uniform and accurate wavelength spacing. This feature can significantly reduce the cost of implementing the optical component.

Because of manufacturing tolerances, the absolute wavelength of the echelle grating may deviate from a target value. However, by changing the effective index of refraction of propagation region 120 using a thermal or another technique (under control of control logic 162), all of the wavelength channels can be tuned simultaneously, thereby providing a tunable comb. On the other hand, to lock the lasing wavelength to a predetermined WDM wavelength grid, monitoring and control of only one wavelength channel may be needed. The remaining wavelength channels will automatically register to the controlled wavelength channel.

In some embodiments, the optical component is also used to receive one or more optical signals (i.e., it is a transceiver). This is shown in FIG. 2, which presents a block diagram illustrating an optical component 200. In particular, this optical component includes an optical waveguide 210-1, optically coupled to wavelength-control device 116 at optical port 212-1, that receives optical signal 214-1 having additional wavelengths. In these embodiments, using the reflective geometry optical device 122 may image and diffract optical signal 214-1 along a fifth direction into optical signals (such as optical signal 216-1) having the additional wavelengths along sixth directions, where a given sixth optical signal includes a given additional wavelength. Furthermore, additional optical paths (such as optical path 220-1), optically coupled to additional optical ports (such as optical port 218-1), may include additional optical waveguides (such as optical waveguide 222-1) and optical detectors (O.D.), such as optical detector 224-1, where a given additional optical path (such as optical path 220-1) includes a given one of the additional optical waveguides (such as optical waveguide 222-1) and a given optical detector (such as optical detector 224-1). The given optical detector may detect the given one of optical signals (such as optical signal 216-1) conveyed by the given one of the additional optical waveguides.

If the optical waveguides are implemented using a submicron silicon-on-insulator (SOI) technology, where only single polarization is supported, the optical component may be modified to provide a polarization-insensitive WDM transceiver with built-in wavelength registration using a polarization-diversity technique. In particular, the two orthogonal polarizations in a single-mode optical fiber may be split in two and processed independently. For example, the two optical signals may be provided by a polarizing splitting grating coupler (PSGC), which may be conveyed to wavelength-control device 116 by two optical waveguides. Wavelength-control device 116 may select wavelength channels and combine the appropriate wavelengths in the optical signals on the two optical waveguides at an optical detector to achieve polarization-independent operation. This is shown in FIG. 3, which presents a block diagram illustrating an optical component 300. In this optical component, optical waveguides 210 may include a pair of optical waveguides that receive different polarization components of optical signals 214. Therefore, optical ports 212 of wavelength-control device 116 may be optically coupled to the pair of optical waveguides 210. In addition, a pair of optical waveguides 222 may be coupled to optical path 220-1 (and, thus, optical detector 224-1) via optical ports 218.

Note that the PSGC (not shown): may split a normal-incident input optical signal with arbitrary polarization (such as that from an optical fiber) into a first optical signal and a second optical signal, which are two orthogonal components aligned with the TE modes of optical waveguides 210; and may couple the first optical signal to optical waveguides 210. For example, diffraction-grating couplers (which are sometimes referred to as ‘grating couplers’) can be designed to couple light between a single-mode optical fiber and silicon optical waveguides. In addition, one- or two-dimensional diffraction gratings can work as a coupler and as a polarization splitter that separates the two orthogonal polarization components in a single-mode optical fiber into two different silicon optical waveguides 210. Note that the power in each of optical waveguides 210 is dependent on the state of polarization of the input optical signal. However, the sum of powers in both optical waveguides 210 is essentially constant. Using the PSGC, the polarization-diversity technique can be implemented to build a polarization-independent optical receiver and/or transceiver, that can support WDM and which can be implemented on silicon (i.e., it is a low-cost optical receiver).

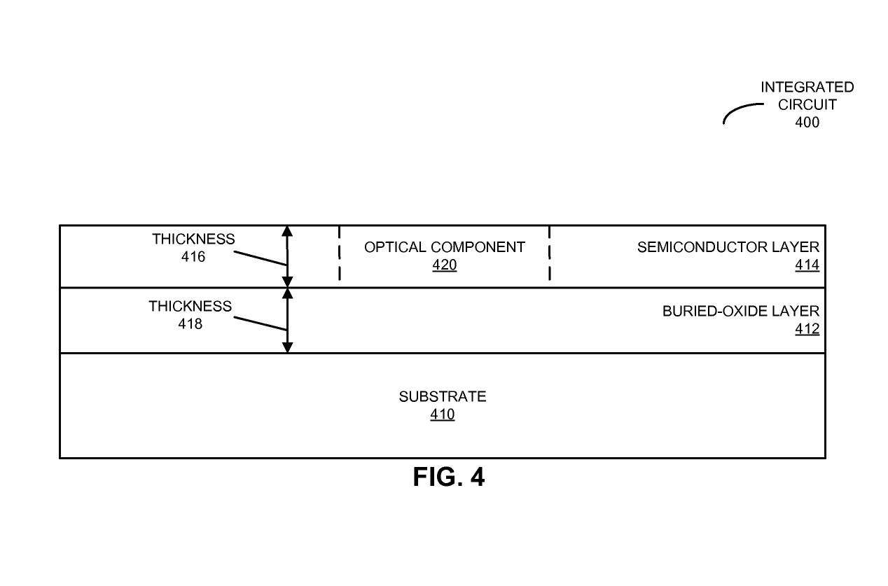

The preceding embodiments of the optical component may, at least in part, be implemented using SOI technology. This is illustrated in FIG. 4, which presents a block diagram illustrating a side view of an integrated circuit 400 that includes optical component 100 (FIG. 1), 200 (FIG. 2) or 300 (FIG. 3). In particular, integrated circuit 400 may include: a substrate 410; a buried-oxide layer 412 disposed on substrate 410; and a semiconductor layer 414 disposed on buried-oxide layer 412. As illustrated by optical component 420, at least optical waveguide 110 (FIGS. 1-3), optical waveguide 128-1 (FIGS. 1-3), optical waveguide 138-1 (FIGS. 1-3), optical waveguide 148 (FIGS. 1-3), at least one of optical waveguides 210 (FIGS. 2-3), at least one of optical waveguides 222 (FIGS. 2-3) and/or wavelength-control device 116 (FIGS. 1-3) may be included in semiconductor layer 414. Note that substrate 410 and/or semiconductor layer 414 may include a semiconductor, such as silicon. In some embodiments, the optical gain mechanisms (such as optical gain mechanism 130-1 in FIGS. 1-3) include a different semiconductor than that in semiconductor layer 414. For example, the active gain medium can be germanium epitaxially grown onto silicon, or a III-V semiconductor hybrid integrated to the optical waveguides (such as optical waveguide 128-1 in FIGS. 1-3) via III-V semiconductor-to-silicon wafer bonding, or III-V semiconductor-to-optical waveguide bonding and/or using butt coupling.

In an exemplary embodiment, optical signals 112, 118, 142 and 144 in FIGS. 1-3, and optical signals 214 and 216 in FIGS. 2 and 3, have wavelengths between 1.1-1.7 μm, such as an optical signal having a fundamental wavelength of 1.3 or 1.55 μm. Moreover, semiconductor layer 414 may have a thickness 416 that is larger than 1 μm (such as 3 μm) or less than 1 μm (such as 0.25-0.3 μm). Optical components 100 and 200 (FIGS. 1 and 2) may be relevant for use with the former, while optical components 100 and 300 (FIGS. 1 and 3) may be relevant for use with the latter. Furthermore, buried-oxide layer 412 may have a thickness 418 between 0.3 and 3 μm (such as 0.8 μm).

Furthermore, the parameters for an exemplary design of an echelle grating are provided in Table 1.

TABLE 1

| | |
|---|---|
| Channel count | 8 |
| Channel spacing (nm) | 1.6 |
| Optical crosstalk (dB) | 20-25 |
| Footprint (μm²) | 500 × 200 |
| Insertion loss | <3 dB |
| Carrier wavelength (nm) | 1550 |
| Free spectral range (nm) | 12.8 |
| Thickness 416 (nm) | 300 |
| Diffraction order | 90 |
| Grating pitch 158 (μm) | 25 |

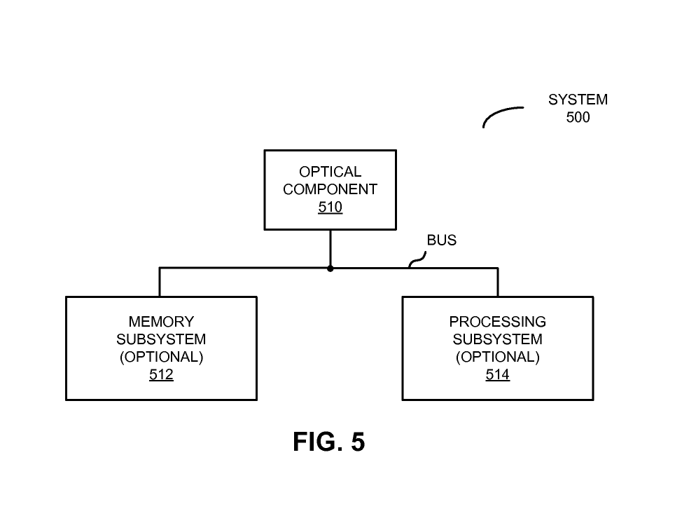

The optical component may be used in a variety of applications. This is shown in FIG. 5, which presents a block diagram illustrating a system 500 that includes optical component 510, such as optical component 100 (FIG. 1), 200 (FIG. 2) or 300 (FIG. 3).

In general, functions of optical component 100 (FIG. 1), optical component 200 (FIG. 2), optical component 300 (FIG. 3), integrated circuit 400 (FIG. 4) and system 500 may be implemented in hardware and/or in software. Thus, system 500 may include one or more program modules or sets of instructions stored in an optional memory subsystem 512 (such as DRAM or another type of volatile or non-volatile computer-readable memory), which may be executed by an optional processing subsystem 514. Note that the one or more computer programs may constitute a computer-program mechanism. Furthermore, instructions in the various modules in optional memory subsystem 512 may be implemented in: a high-level procedural language, an object-oriented programming language, and/or in an assembly or machine language. Note that the programming language may be compiled or interpreted, e.g., configurable or configured, to be executed by the processing subsystem.

Components in system 500 may be coupled by signal lines, links or buses. These connections may include electrical, optical, or electro-optical communication of signals and/or data. Furthermore, in the preceding embodiments, some components are shown directly connected to one another, while others are shown connected via intermediate components. In each instance, the method of interconnection, or ‘coupling,’ establishes some desired communication between two or more circuit nodes, or terminals. Such coupling may often be accomplished using a number of circuit configurations, as will be understood by those of skill in the art; for example, AC coupling and/or DC coupling may be used.

In some embodiments, functionality in these circuits, components and devices may be implemented in one or more: application-specific integrated circuits (ASICs), field-programmable gate arrays (FPGAs), and/or one or more digital signal processors (DSPs). Furthermore, functionality in the preceding embodiments may be implemented more in hardware and less in software, or less in hardware and more in software, as is known in the art. In general, system 500 may be at one location or may be distributed over multiple, geographically dispersed locations.

System 500 may include: a VLSI circuit, a switch, a hub, a bridge, a router, a communication system (such as a WDM communication system), a storage area network, a data center, a network (such as a local area network), and/or a computer system (such as a multiple-core processor computer system). Furthermore, the computer system may include, but is not limited to: a server (such as a multi-socket, multi-rack server), a laptop computer, a communication device or system, a personal computer, a work station, a mainframe computer, a blade, an enterprise computer, a data center, a portable-computing device, a tablet computer, a supercomputer, a network-attached-storage (NAS) system, a storage-area-network (SAN) system, a media player (such as an MP3 player), an appliance, a subnotebook/netbook, a tablet computer, a smartphone, a cellular telephone, a network appliance, a set-top box, a personal digital assistant (PDA), a toy, a controller, a digital signal processor, a game console, a device controller, a computational engine within an appliance, a consumer-electronic device, a portable computing device or a portable electronic device, a personal organizer, and/or another electronic device. Note that a given computer system may be at one location or may be distributed over multiple, geographically dispersed locations.

Moreover, the optical component can be used in a wide variety of applications, such as: optical communications (for example, in an optical interconnect or an optical link), manufacturing (cutting or welding), a lithographic process, data storage (such as an optical-storage device or system), medicine (such as a diagnostic technique or surgery), a barcode scanner, entertainment (a laser light show), and/or metrology (such as precision measurements of distance).

Furthermore, the embodiments of the optical component, the integrated circuit and/or the system may include fewer components or additional components. For example, the optical component may receive or output one or more optical signals using an optical fiber instead of an optical waveguide. Although these embodiments are illustrated as having a number of discrete items, these optical components, integrated circuits and the system are intended to be functional descriptions of the various features that may be present rather than structural schematics of the embodiments described herein. Consequently, in these embodiments two or more components may be combined into a single component, and/or a position of one or more components may be changed. In addition, functionality in the preceding embodiments of the optical component, the integrated circuit and/or the system may be implemented more in hardware and less in software, or less in hardware and more in software, as is known in the art.

In the preceding description, we refer to ‘some embodiments.’ Note that ‘some embodiments’ describes a subset of all of the possible embodiments, but does not always specify the same subset of embodiments.

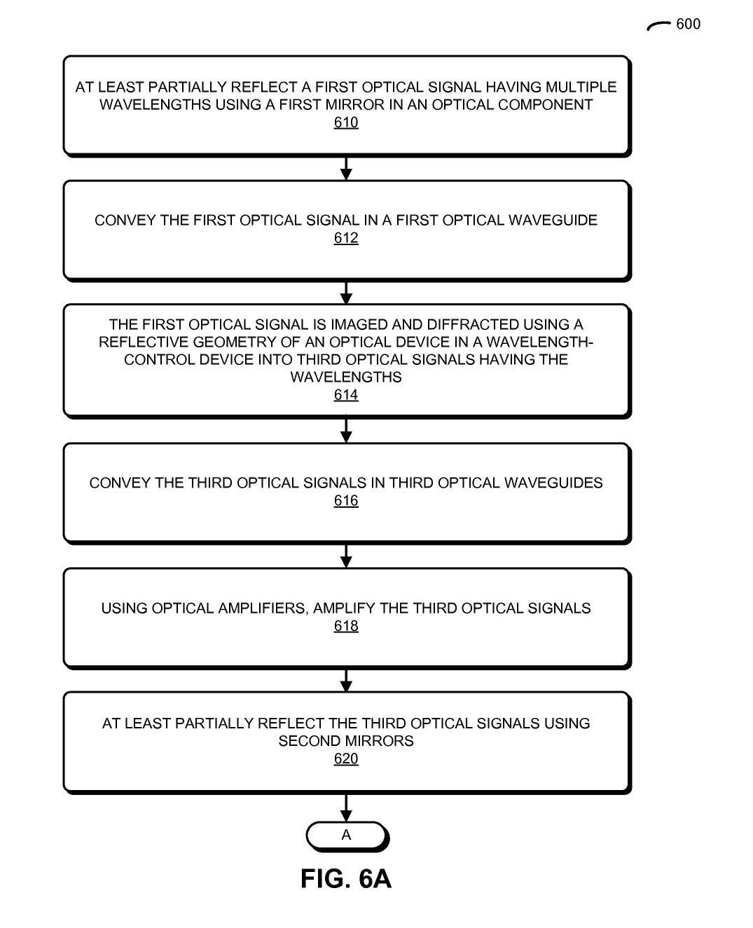

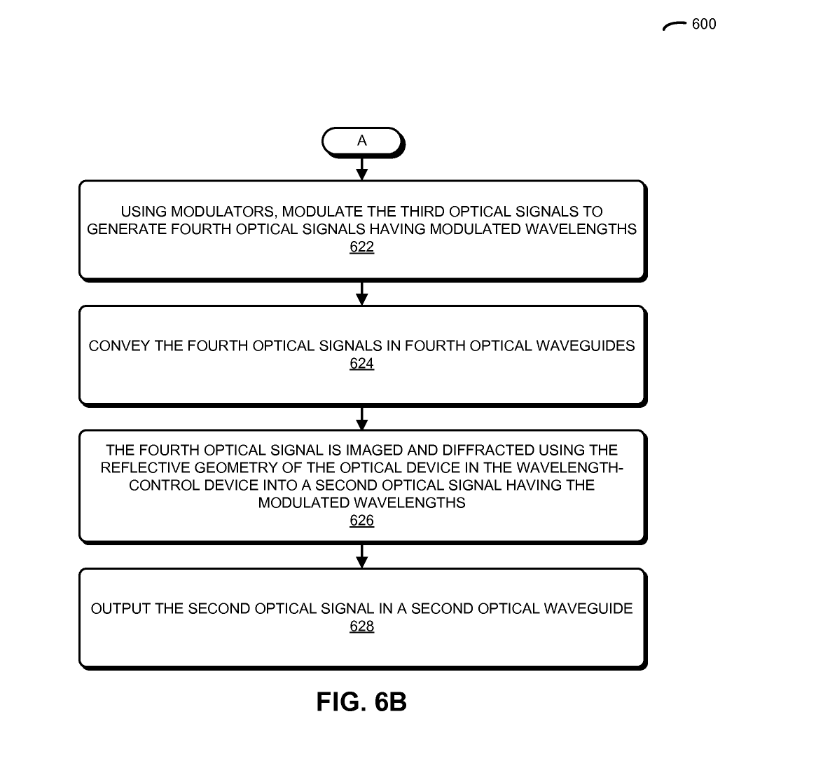

We now describe embodiments of the method. FIGS. 6A and 6B present a flow chart illustrating a method 600 for providing an optical signal, which may be performed by an optical component (such as optical component 100 in FIG. 1, optical component 200 in FIG. 2, or optical component 300 in FIG. 3). During operation, the first optical signal having multiple wavelengths is at least partially reflected using the first mirror (operation 610). Then, the first optical signal is conveyed in the first optical waveguide (operation 612). Moreover, using the reflective geometry of the optical device in the wavelength-control device, the first optical signal along the first direction is imaged and diffracted into the third optical signals having the wavelengths (operation 614) along the third directions, where the given third optical signal includes the given wavelength.

Next, the third optical signals are conveyed in the third optical waveguides (operation 616), where the given third optical waveguide conveys the given third optical signal. Furthermore, the third optical signals are amplified using the optical gain mechanisms (operation 618) optically coupled to the third optical waveguides, where the given optical gain mechanism amplifies the given third optical signal. Additionally, the third optical signals are at least partially reflected using the second mirrors (operation 620), where the given second mirror at least partially reflects the given third optical signal.

Then, the third optical signals are modulated using the modulators to generate the fourth optical signals having the modulated wavelengths (operation 622). The fourth optical signals are conveyed in the fourth optical waveguides (operation 624), where the given fourth optical waveguide includes the given fourth optical signal. Next, using the reflective geometry of the optical device in the wavelength-control device, the fourth optical signals along the fourth directions are imaged and diffracted into the second optical signal having the modulated wavelengths along the second direction (operation 626), where the given fourth optical signal includes the given modulated wavelength. Furthermore, the second optical signal is output in the second optical waveguide (operation 628).

In some embodiments of method 600 there are additional or fewer operations. Moreover, the order of the operations may be changed, and/or two or more operations may be combined into a single operation.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An optical component, comprising:
a first mirror configured to at least partially reflect a first optical signal having multiple wavelengths;
a first optical waveguide, optically coupled to the first mirror, configured to convey the first optical signal;
a second optical waveguide configured to output a second optical signal having multiple modulated wavelengths;
a wavelength-control device, optically coupled to the first optical waveguide and the second optical waveguide, including an optical device configured to image and diffract using a reflective geometry: the first optical signal along a first direction into third optical signals having the wavelengths along third directions, and fourth optical signals having the modulated wavelengths along fourth directions into the second optical signal along a second direction, wherein a given third optical signal includes a given wavelength and a given fourth optical signal includes a given modulated wavelength; and
optical paths, optically coupled to pairs of diffraction orders of the optical device, including: third optical waveguides configured to convey the third optical signals, optical gain mechanisms configured to amplify the third optical signals, second mirrors configured to at least partially reflect the third optical signals, modulators configured to generate the fourth optical signals by modulating the third optical signals, and fourth optical waveguides configured to convey the fourth optical signals.

2. The optical component of claim 1, wherein a given optical path includes:
a given third optical waveguide, optically coupled to a given diffraction order, configured to convey the given third optical signal;
a given optical gain mechanism, optically coupled to the given third optical waveguide, configured to amplify the given third optical signal; and
a given second mirror, optically coupled to the given third optical waveguide, configured to at least partially reflect the given third optical signal.

3. The optical component of claim 1, wherein the optical paths further include optical phase-tuning mechanisms; and
wherein a given optical phase-tuning mechanism is optically coupled to the given third optical waveguide and is configured to adjust a phase of the given third optical signal.

4. The optical component of claim 3, wherein the optical phase-tuning mechanisms have a different band gap than that of the optical gain mechanisms.

5. The optical component of claim 3, wherein the optical phase-tuning mechanisms include heaters configured to modify temperatures of the optical phase-tuning mechanisms.

6. The optical component of claim 1, wherein the first mirror includes a distributed Bragg reflector; and
wherein the second mirrors include distributed Bragg reflectors.

7. The optical component of claim 1, wherein the first mirror includes a metal disposed on a surface of the first optical waveguide; and
wherein the second mirrors include metal disposed on surfaces of the third optical waveguides.

8. The optical component of claim 1, wherein the optical gain mechanisms are configured to receive electrical currents to electrically pump the third optical signals.

9. The optical component of claim 1, wherein a given optical path includes:
a given modulator, optically coupled to a given second mirror, configured to modulate the given third optical signal to generate the given fourth optical signal; and
a given fourth optical waveguide, optically coupled to a given diffraction order, configured to convey the given fourth optical signal.

10. The optical component of claim 1, wherein the modulators include cascaded ring-resonator modulators.

11. The optical component of claim 1, wherein an incidence angle associated with a given diffraction order of the optical device is different than a diffraction angle associated with the given diffraction order.

12. The optical component of claim 1, wherein the optical device includes a diffraction grating on a curved surface.

13. The optical component of claim 1, wherein the optical device includes an echelle grating.

14. The optical component of claim 1, further comprising:
a substrate;
a buried-oxide layer disposed on the substrate; and
a semiconductor layer disposed on the buried-oxide layer, wherein the first optical waveguide, the second optical waveguide, the third optical waveguides and the fourth optical waveguides are included in the semiconductor layer.

15. The optical component of claim 14, wherein the substrate includes a semiconductor.

16. The optical component of claim 14, wherein the wavelength-control filter is included in the semiconductor layer.

17. The optical component of claim 14, wherein the optical gain mechanisms include at least a different semiconductor than that in the semiconductor layer.

18. The optical component of claim 1, further comprising:
a fifth optical waveguide, optically coupled to the wavelength-control device, configured to receive a fifth optical signal having additional wavelengths, wherein, using the reflective geometry, the optical device is configured to image and diffract the fifth optical signal along a fifth direction into sixth optical signals having the additional wavelengths along sixth directions, and wherein a given sixth optical signal includes a given additional wavelength; and
additional optical paths, optically coupled to additional diffraction orders of the optical device, including sixth optical waveguides and optical detectors, wherein a given additional optical path includes a given sixth optical waveguide and a given optical detector; and
wherein the given optical detector is configured to detect the given sixth optical signal conveyed by the given sixth optical waveguide.

19. The optical component of claim 18, wherein the fifth optical waveguide includes a pair of optical waveguides configured to receive different polarization components of the fifth optical signal; and
wherein the wavelength-control device is optically coupled to the pair of optical waveguides.

20. A method for providing optical signals, wherein the method comprises:
using a first mirror, at least partially reflecting a first optical signal having multiple wavelengths;
conveying the first optical signal in a first optical waveguide;
using a reflective geometry of an optical device in a wavelength-control device, imaging and diffracting the first optical signal along a first direction into third optical signals having the wavelengths along third directions, wherein a given third optical signal includes a given wavelength;
conveying the third optical signals in third optical waveguides, wherein a given third optical waveguide conveys the given third optical signal;
amplifying the third optical signals using optical gain mechanisms optically coupled to the third optical waveguides, wherein a given optical gain mechanism amplifies the given third optical signal;
at least partially reflecting the third optical signals using second mirrors, wherein a given second mirror at least partially reflects the given third optical signal;
modulating the third optical signals using modulators to generate fourth optical signals having modulated wavelengths;
conveying the fourth optical signals in fourth optical waveguides, wherein a given fourth optical waveguide includes a given fourth optical signal;
using the reflective geometry of the optical device in the wavelength-control device, imaging and diffracting the fourth optical signals along fourth directions into a second optical signal having the modulated wavelengths along a second direction, wherein the given fourth optical signal includes a given modulated wavelength; and
outputting the second optical signal in a second optical waveguide.
